(19) United States
(12) Patent Application Publication
(10) Pub. No.: US 2017/0138530 A1
(43) Pub. Date: May 18, 2017

(54) CARRIER MOUNT FOR A MONITOR OF A COMPUTER SYSTEM AS WELL AS ASSEMBLY WITH A CARRIER MOUNT

(71) Applicant: Fujitsu Technology Solutions Intellectual Property GmbH, Munchen (DE)

(72) Inventors: Wilhelm Neukam, Bobingen (DE); Toni Koberling, Grafelfing (DE); Johann Schweinfort, Augsburg (DE); Tobias Barl, Augsburg (DE)

(21) Appl. No.: 15/349,123

(22) Filed: Nov. 11, 2016

(30) Foreign Application Priority Data
Nov. 18, 2015 (DE) 10 2015 119 976.9

(51) Int. Cl. F16M 11/10; G06F 1/16; F16M 11/22; G06F 1/18; A47B 97/00; A47B 88/04

(52) U.S. Cl. CPC F16M 11/10; A47B 97/00; A47B 88/04; A47B 88/0455; F16M 11/22; G06F 1/181; G06F 1/1601; A47B 2097/005; A47B 2097/006

(57) ABSTRACT

A carrier mount for a monitor of a computer system includes a base plate, two side walls arranged oppositely on the base plate, and a cover plate arrangable at the side walls so that, together with the side walls and the base plate, a receiving space is defined, wherein the receiving space is formed such that a computer system can selectively at least partially be received therein or a drawer can be inserted.

### TECHNICAL FIELD

This disclosure relates to a carrier mount for a monitor of a computer system and further relates to assemblies with such a carrier mount.

### BACKGROUND

Carrier mounts for a monitor of a computer system are known. Typically, such carrier systems serve to carry as well as the stable and secure set up of a monitor mounted thereon on a standing surface. Furthermore, carrier mounts, which can also be referred to as pedestal, for example, allow for the position of a monitor to be varied and a desired viewing angle to be adapted depending on the viewer.

It could therefore be helpful to provide a carrier mount for a monitor of a computer system characterized by multi-purpose application of the carrier mount.

### SUMMARY

We provide a carrier mount for a monitor of a computer system including a base plate, two side walls arranged oppositely on the base plate, and a cover plate arrangable at the side walls so that, together with the side walls and the base plate, a receiving space is defined, wherein the receiving space is formed such that a computer system can selectively at least partially be received therein or a drawer can be inserted.

We also provide an assembly with the carrier mount for a monitor of a computer system including a base plate, two side walls arranged oppositely on the base plate, and a cover plate arrangable at the side walls so that, together with the side walls and the base plate, a receiving space is defined, wherein the receiving space is formed such that a computer system can selectively at least partially be received therein or a drawer can be inserted, and a computer system, wherein the carrier mount includes a base plate, two side walls arranged opposite the base plate, and a cover plate arranged on the side walls so that, together with the side walls and the base plate, a receiving space is defined, the carrier mount includes a holding arm for the monitor, the cover plate is configured as a mounting plate on which a housing of the computer system is fixed, and a drawer can be inserted in the receiving space.

We further provide an assembly with the carrier mount for a monitor of a computer system including a base plate, two side walls arranged oppositely on the base plate, and a cover plate arrangable at the side walls so that, together with the side walls and the base plate, a receiving space is defined, wherein the receiving space is formed such that a computer system can selectively at least partially be received therein or a drawer can be inserted, and a computer system, wherein the carrier mount includes a base plate, two side walls arranged opposite the base plate, and a cover plate arranged on the side walls so that, together with the side walls and the base plate, a receiving space is defined, the carrier mount includes a holding arm for the monitor, and the computer system is at least partially received in the receiving space.

### BRIEF DESCRIPTION OF THE DRAWINGS

FIG. 1 shows a schematic perspective view of a carrier mount with a drawer.

FIG. 2 shows a further schematic, perspective view of the carrier mount upon assembly of a computer system.

FIG. 3 shows a perspective, exploded view of a carrier mount according to FIGS. 1 and 2.

FIGS. 4 and 5 show perspective partial views of an assembly with the carrier mount according to an example.

FIGS. 6 and 7 show perspective partial views of an assembly with the carrier mount according to another example.

### LIST OF REFERENCE NUMERALS

1 carrier mount
2 base plate
3 side walls
4 cover plate
5 receiving space
6 holding arm
7 tab
8 front side
9 stop element
10 base unit
11 base portion
12 base cover
13 back side
14 drawer
15 mounting area
16 guide element
17 reinforcement plate
18 bore
19 opening
20 grip element
21 mounting adapter
22 holding clamp
25 assembly
26 monitor
27 screws
30 computer system
31 housing

### DETAILED DESCRIPTION

A carrier mount for a monitor of a computer system is disclosed. The carrier mount comprises a base plate, as well as two side walls, arranged oppositely on the base plate. Furthermore, a cover plate that can be arranged at the side walls is provided so that together with the side walls and the base plate a receiving space is defined. The receiving space is configured such that selectively a computer system can at least partially be received therein or a drawer can be inserted.

The carrier system described herein is characterized in that selectively a drawer or a computer system can be inserted in the receiving space. According to the needs and wants of the customer, the space available in the receiving space is used differently.

On the one hand, it is possible to receive the computer system at least in part therein. A computer system is, for example, considered to be a computing unit encapsulated in a computer housing and comprises one or multiple ports such as peripheral ports. Such a computer system is a so-called mini PC characterized by compact outer dimensions. It is placed on the base plate, for example, and at least partially inserted or laid into the receiving space from a front side.

On the other hand, it is possible to insert the drawer into the receiving area. Cables or lines, leading from a computer system to a screen or respectively a monitor fixed on the carrier mount, a power supply adaptor or the like, which powers the computer system, can be received therein. This does not only eliminate eventual disorganizations such as unorganized cables on a supporting surface of the carrier mount such as a desk, but also to increase the safety against undesired unplugging of cables or the like. For example, the cables or the like can be securely stored and/or guided in a bundle via the drawer.

The arrangable cover plate is, for example, fixedly, e.g., non-detachable, connected with the side walls. Alternatively, the cover plate is detachably arranged on the side walls. In further configurations, the cover plate is formed integrally with the side walls.

The side walls may be formed such that a holding arm for the monitor can be attached or fixed on the side walls and/or the cover plate. Typically, the holding arm is an L-shaped arm, fixed to the side walls and/or the cover plate with one end and provided with a monitor on the opposite end. In other words, the carrier mount comprises the support arm that may be fixed to the carrier mount via a leg and mechanically connected to a monitor via another leg. The holding arm has a mounting adapter to mount the monitor. The mounting adapter is a mounting plate pursuant to the VESA-Standard, for example. This mounting plate is fixed to the holding arm in an articulated manner so that the position of a monitor fixed thereon can be adjusted.

The side walls comprise mounting surfaces, for example. The mounting surfaces are arranged parallel to the base surface, for example. These are tabs of the side walls directed inwards, for example. The tabs can be formed or bent out of the side walls. For example, the holding arm mechanically connects or is screwed, for example, to such tabs or mounting areas. For example, the area of the holding arm connected to the side walls is covered by the covering plate so that the holding arm is encapsulated in this region. Instead of screw connections, other fixing types are also suitable. Alternatively, the tabs or mounting surfaces can be provided or designed differently, for example, parallel to the side walls such as perpendicular to the base plate.

The receiving space may be configured to be open on a front side and a back side. This allows the drawer to be inserted from the back side, for example, whereas the computer system can be inserted from the front.

A side wall and/or the base plate may comprise a first guide element. The first guide element permits insertion of the drawer and is configured accordingly. The guide element is a rail or a rail system, one or multiple ribs, grooves or link guides, for example. The first guide element allows for safe and guided insertion of the drawer. Alternatively, the first guide element at least partially permits insertion of the computer system into the receiving space at the same time. In further configurations, a plurality of first guide elements is provided, for example, on both side walls.

At least one locking element, a latching element and/or a clamping element may be provided on a side wall and/or the base plate to lock, latch and/or clamp with the drawer. In an inserted state, the drawer can be prevented from being pushed or pulled out. This prevents the drawer from undesirably falling out of the receiving space. This is particularly useful if the carrier mount is transported with or without a computer system. In other words, the drawer is held in the receiving space by a form fit and/or frictional fit.

A stop element may be arranged on the base plate and/or a side wall. The stop element brings about a location positioning or location centralization of the computer system upon insertion of this system in the receiving space. By the abutting element, a fixed position can be predefined for the computer system in the receiving space. This facilitates mounting the computer system on the carrier mount. Thereby, it is achieved, for example, that in threaded bores of the computer system or a housing thereof, respectively, these bores are aligned with corresponding bores in the base plate and/or the side walls. This way, the computer system can be screwed to the carrier mount in a simple manner without having to elaborately position the computer system for mounting purposes.

A side wall and/or the base plate may comprise a second guide element. The second guide element permits insertion of the computer system. This way, a location positioning or location centralization is achieved in a manner analogous to the one mentioned above. The second guide element is configured analogous to the one mentioned above.

Alternatively, the computer system is guided via the side walls, wherein no further guide elements are provided. In other words, the shape of the side walls is adapted to a housing of the computer system such that guidance of the computer system is enabled. In particular, a distance between the side walls is adapted to the shape of the computer system.

The cover plate may be slidably guided along the side walls. Thus, the cover plate can be inserted between the side walls. This allows for particularly easy mounting of the cover plate. The side walls comprise further guide elements analogous to the above, to that end, for example. The side walls are alternatively shaped such that they have guides for the cover plate. This allows for the cover plate to be provided with further components prior to insertion, for example, such as reinforcement plates or a computer system mounted thereon, wherein the cover plate can subsequently be inserted together with the further component(s). In other words, the cover plate can be prepared previously, separate from the remaining carrier mount.

The cover plate may be configured as a mounting plate on which the computer system, in particular a housing of the computer system, can be fixed from the outside. For example, the mounting plate comprises one or multiple bores, via which the mounting plate is screwed to the housing of a computer system. Alternatively, other fixing options are suitable.

The cover plate may comprise a mounting area for the computer system and a reinforcement plate is arranged in the area of the mounting area at and on an inner side of the cover plate facing the receiving space. The cover plate can thereby be reinforced in the region of the mounting area. In particular, if a computer system is mounted on the cover plate, withdrawal of the computer system from the cover plate can be avoided or even be prevented. The reinforcement plate is of particular advantage when the cover plate is made of a plastic material. The reinforcement plate is made of a metal material, for example, that typically has a higher strength compared to a plastic material. The plastic material is suitable, for example, to be able to produce the cover plate in a simple manner and integrally, despite provision of various elements such as a latch element, for example, arranged thereon. In other words, many functions can be integrated in the cover plate. For example, the cover plate is produced by an injection molding process.

The cover plate may comprise a latch element configured to latch the cover plate with the side walls and/or with a holding arm for a monitor mounted on the carrier mount. This ensures that the cover plate can be safely mounted.

The cover plate may comprise a bore, in a particular a threaded bore, to screw the cover plate to a holding arm for the monitor mounted on the carrier mount. This secures the cover plate on the holding arm and/or the side walls. The cover plate is therefore protected from undesired demounting or pull-out.

The cover plate may comprise an opening configured to receive a so-called Kensington lock. This way, the cover plate can be secured on a holding arm mounted on the carrier mount and/or the side walls for the monitor.

Furthermore, we provide an assembly with the carrier mounts above and with a computer system. The carrier mount comprises a base plate, two side walls arranged opposite the base plate, and a cover plate that may be arranged at the side walls so that together with the side walls and the base plate a receiving space is defined. The carrier mount comprises a holding arm for the monitor. For example, the holding arm is arranged on the side walls. The cover plate is configured as a mounting plate on which a housing of the computer system is attached. A drawer can be inserted in the receiving space.

The assembly essentially allows for the advantages and functions mentioned above.

The cover plate can be slidably guided along the side walls and the computer system may initially be only mounted on the cover plate via the housing and subsequently inserted together with the cover plate. This facilitates mounting of the computer system.

We also provide an assembly with the above carrier mounts and a computer system. The carrier mount comprises a base plate, two side walls and a cover plate that may be arranged at the side walls so that together with the side walls and the base plate, a receiving space is defined. The carrier mount comprises a holding arm for the monitor. The holding arm is arranged on the side walls, for example. The computer system is at least partially received in the receiving space.

The assembly essentially allows for the advantages and functions mentioned above.

The features and functions described in the scope of the carrier mount can form part of the described assemblies.

Furthermore, a combination of the described assemblies is possible such that both a computer system can at least partially be inserted in the receiving space and a further computer system is mounted on the cover plate or mounting plate.

It should be noted that, instead of the computer system, also another electronic device such as a power supply unit, can be provided.

In the following, the examples are described using the accompanying Figures. Items identical in construction or function are provided with the same reference numerals throughout the Figures.

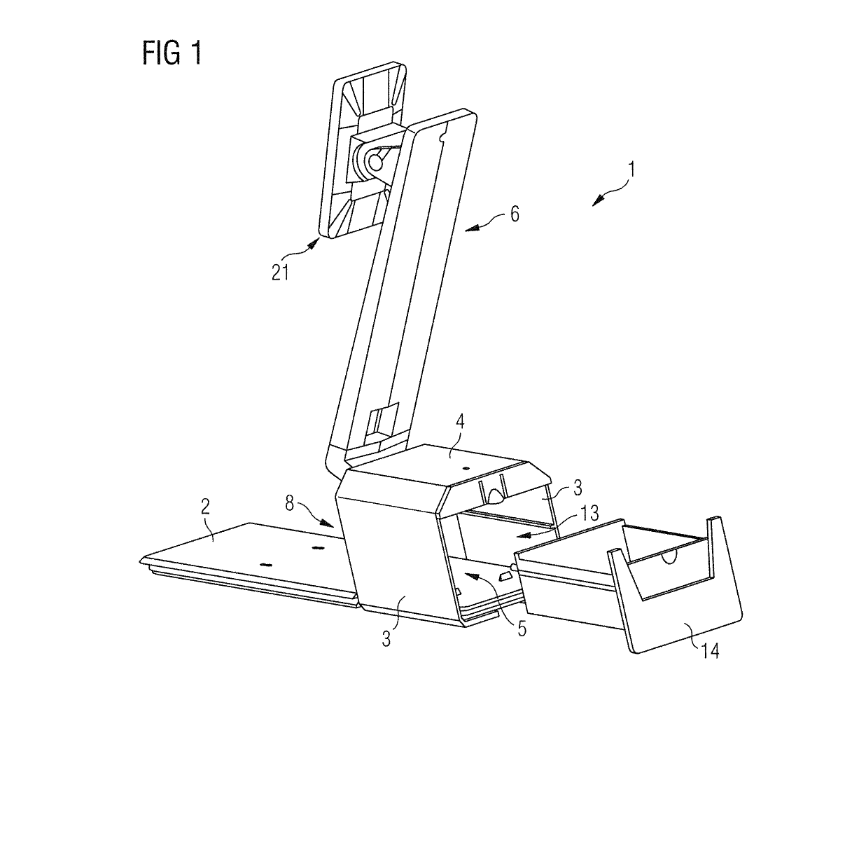

FIG. 1 schematically shows a carrier mount 1 for a monitor of a computer system. The carrier mount 1 has a base plate 2, on the one end of which two side walls 3 are arranged oppositely. Both side walls 3 are arranged perpendicular to a base surface of the base plate 2 along the plate. A cover plate 4 is arranged on both side walls 3, connecting these side walls 3 as seen in FIG. 1. The side walls 3 typically only extend over a part of the length of the base plate 2. Alternative configurations are possible. The cover plate 4 forms a receiving space 5 together with the side walls 3 and the corresponding portion of the base plate 2, defining a cavity. The receiving space 5 is configured to be open on a front side 8 and a back side 13. Furthermore, a holding arm 6 is mounted on the side walls 3. The holding arm 6 has a mounting adapter 21 for mechanical coupling with a screen or a monitor of a computer system. Furthermore, an optional drawer 14 is shown in FIG. 1, which can be inserted in the receiving space 5 from the back side 13. Details of the insertion of the drawer 14 and the cover plate 4 will be described later.

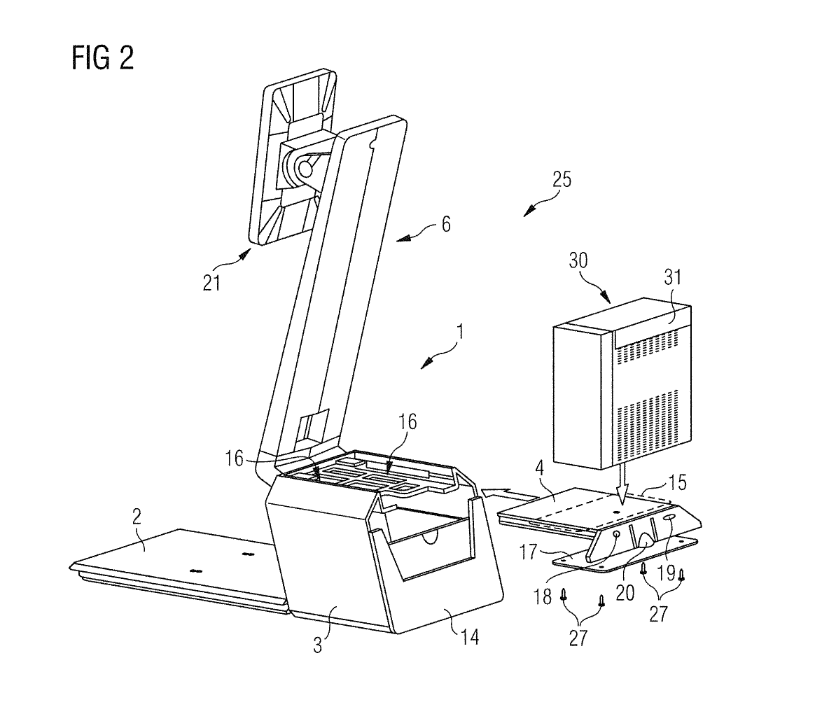

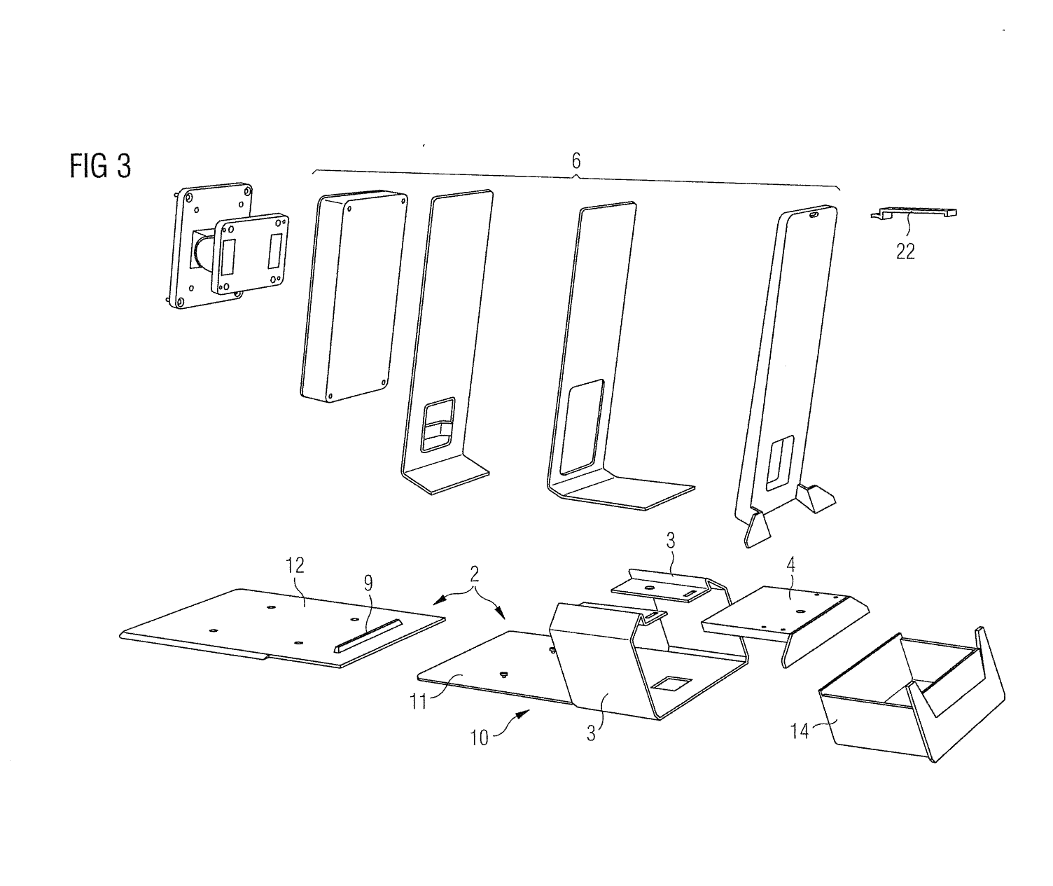

FIG. 3 shows the carrier mount 1 in an exploded view. As clarified by the curly bracket, the holding arm 6 is formed of multiple sub-components, not described in further detail herein. As illustrated in FIG. 3, the side walls 3 respectively comprise tabs 7 pointing inwards, on which the holding arm 7 is fixed. Fixing is effected by screw connections, but can alternatively be performed differently. The mounting adaptor 21 is configured pursuant to the VESA standard. Alternatively, the holding arm 6 can have other configurations as well as more or less sub-components. The mounted state of holding arm 6 on the side walls 3 is shown in FIG. 2, for example, in which the cover plate 4 is shown prior to mounting on the carrier mount 1.

FIG. 3 further clarifies that the base plate 2 is designed in two parts. In particular, the carrier mount 1 comprises a base unit 10 on which the side walls 3 are formed and which has a base portion 11. The base unit 10 and the side walls 3 are produced integrally from a metal material, for example, by a punching or stamping method. The base unit 10 is a formed metal sheet, for example. A base covering 12 is attached to the base portion 11 of the base unit 10. The base covering 12 is produced from a plastic material, for example. Alternatively, the base unit 10 does not comprise a base covering 12 and the base portion 11 constitutes the base plate 2. Thus, the side walls 3 and the base plate 2 are produced integrally. It should be noted that the term base plate refers both to integral as well as multi-part configurations. The base unit 10 and the base plate 2 constitute a base body of the carrier mount 1.

Furthermore, an optional holding bracket 22 is shown in FIG. 3, to which reference is made later.

The carrier mount 1 is a carrier mount of modular use. The carrier mount 1 in particular allows for various purposes, as described in the following.

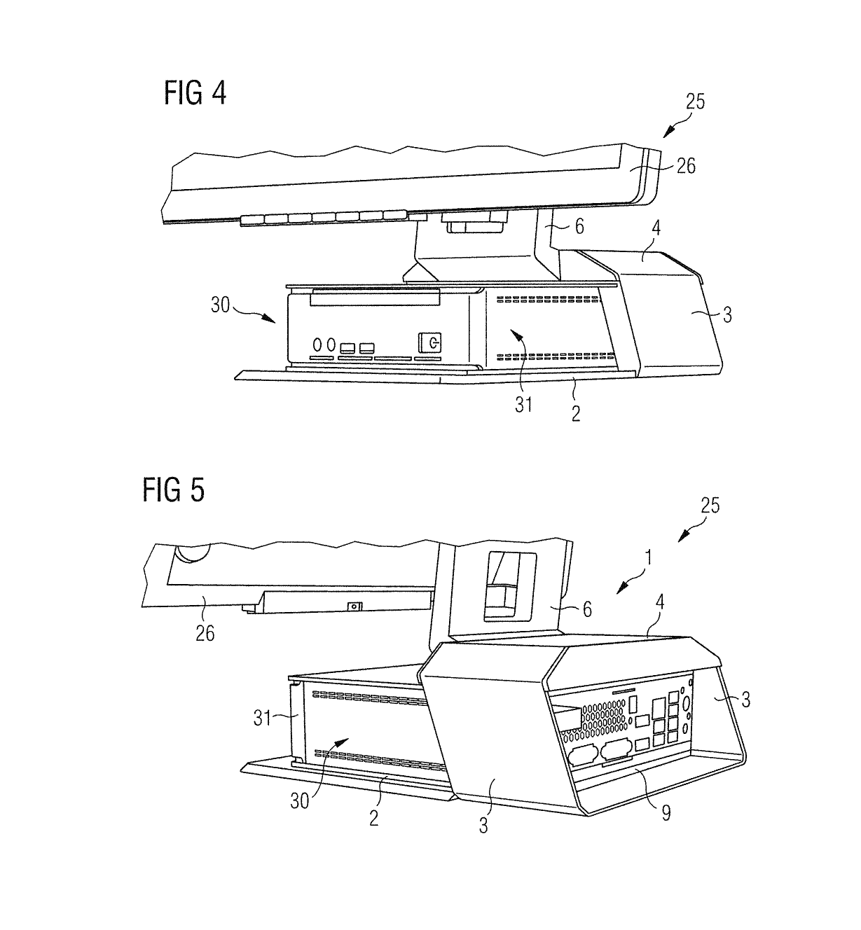

FIGS. 4 and 5 show an exemplary assembly 25 in perspective partial views according to an example. The assembly 25 comprises a carrier mount 1 with a holding arm 6 as described above. A monitor 26 is mounted on the holding arm 6. Furthermore, instead of the drawer 14 shown in FIG. 1, a computer system 30 is at least partially inserted into the receiving space 5 from the front side 8 of the receiving space 5. The computer system 30 can thereby be stowed particularly easy. In this case, the ports arranged on a backside of the computer system 30, for example, peripheral ports such as USB ports or graphics card ports are located within the receiving space 5 and are thus at least partially better protected against undesired access compared to exposed ports as shown in FIG. 5.

In the example, one or multiple guide elements are provided on the base plate 2 to insert the computer system 30 in the receiving space 4. These are, for example, guide ribs or guide grooves which interact with a housing 31 of the computer system 30, in particular the bottom side of the housing. Optionally, the housing 31 of the computer system 30 comprises corresponding counter elements for interaction with the guide element(s). This allows for guiding the computer system 30 in a simple and targeted manner into the receiving space 5. In examples not shown herein, in addition or as an alternative, guide elements for guiding the computer system 30 or respectively its housing 31 on one or both side walls 3 can be provided. In further examples not shown herein, no guide elements are provided, wherein the shape of the side walls 3 is adapted to the housing 31 of the computer system 30 such that the side walls ensure guidance when inserting the computer system 30.

Furthermore, optionally a stop element 9 is provided as shown in FIGS. 3 and 5. The stop element 9 limits the insertion of the computer system 30. A defined location position of the computer system 30 is thereby predetermined so that it can be mounted in a particularly simple manner. In this example, bores are provided in the base plate 2 to that end, which bores, after the stop of the computer system 30 on the stop element 9, are aligned with corresponding bores in the housing 31 of the computer system 30.

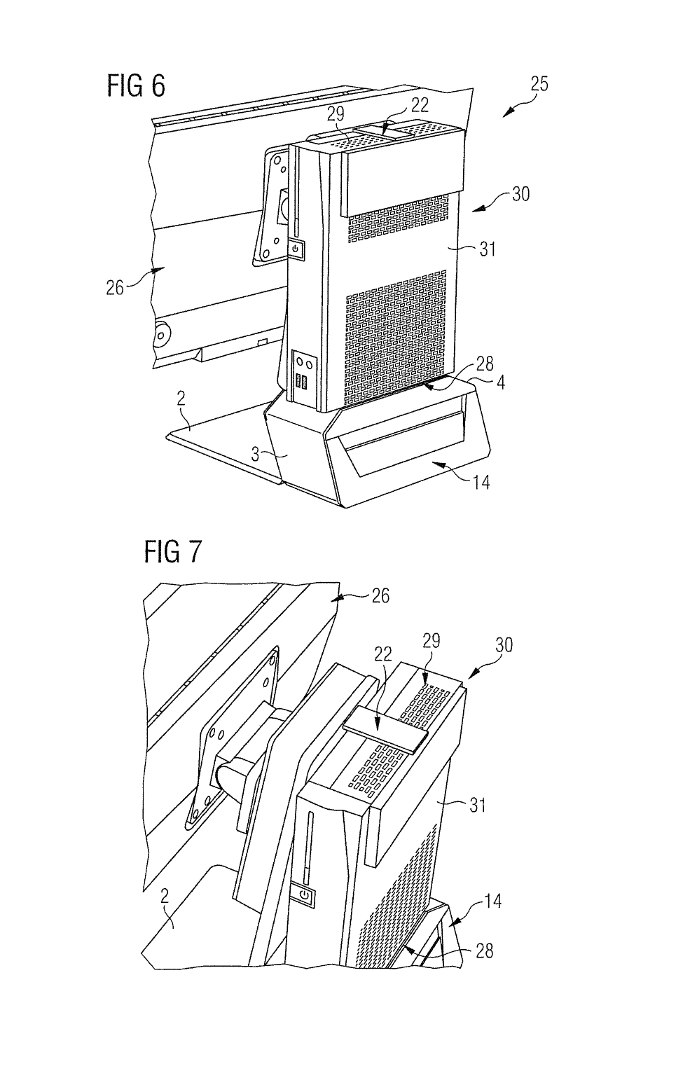

FIGS. 6 and 7 show another assembly 25 in perspective partial views. Another application option of the carrier mount 1 is shown, wherein, instead of the computer system 30, a drawer 14 is inserted into the receiving space 5 from a backside 13 as also shown in FIGS. 1 and 2. For example, drawer 14 terminates flush with the side walls 3 and the base plate 2 in the inserted state. The drawer 14 allows for receiving cables, lines or adaptors such as an AC (alternating current) adaptor and protect it against undesired access of a third person. Also, unorganized cables are prevented, which can undesirably lead to errors in a computer system.

Besides the FIGS. 6 and 7 as well shown in FIG. 2, cover plate 4 is optionally adapted for mounting a computer system 30. To that end, cover plate 4 comprises a mounting area 15, on which the computer system 30 is mounted via the housing 31 thereof from the outside. Mounting the computer system 30 is effected upright. For example, the computer system 30 is screwed via an inner side of the cover plate 4 facing the receiving space 5. The cover plate 4 is thus configured as a mounting plate. The assembly of the computer system 30 outside the mounting plate is, for example, advantageous to cool the computer system 30. For example, effectiveness of the cooling is increased when cold air is suctioned via an underside 28 of the computer system 30 or in an area of the underside 28, shown in FIGS. 6 and 7 below, and is blown-out over an opposite top side 29 or in an area of the top side 29. By this assembly of the computer system 30, the computer system is stowed on the carrier mount 1 in a particularly space-saving manner. Cables or the like of the computer system 30 can be stowed in the drawer 14 safely and/or in a guided manner. This results in a compact assembly 25 with the carrier mount 1.

As shown in FIG. 2, mounting of the computer system 30 is effected on the cover plate 4 apart from the remaining components of the carrier mount 1. Subsequently, the cover plate 4 with the mounted computer system 30 is inserted in the side walls 3. To that end, guide elements 16 are, for example, provided on the side walls 3. The guide elements 16 are, for example, link guides. The link guides are, for example, configured as U-shaped rail guides. Alternatively, the guide elements are configured as rails, rail systems, grooves, ribs or the like. The cover plate 4 is configured in accordance with the guide elements 16 to interact with the same.

Optionally, a reinforcement plate 17 is fixed in the area of the mounting area 15 on the inner side of the cover element 4. For example, the reinforcement plate 17 is fixed on the cover plate 4 by screws 27. Alternative ways of fixing are possible. The reinforcement plate 17 allows for the above mentioned advantages, in particular, if the cover plate 4 like in the example is made of a plastic material. The reinforcement plate 17 is thus fixedly connected to the cover plate 4 in a mechanical manner.

As shown in FIG. 2, the cover plate 4 optionally has a bore 18, via which the cover plate 4 is screwed to the holding arm 6. The screw connection is, for example, effected with a lower leg or on a lower end of the holding arm 6. Thereby, the cover plate 4 can be protected from an undesired withdraw of the cover plate 4 from the side walls 3.

Alternatively or additionally to the bore 18, a further opening 19 can be provided, which is configured to receive a so-called “Kensington Lock.” Via the opening 19 and via the Kensington Lock, the cover plate 4 can be secured in an inner area of the receiving space 5. In particular, the carrier mount 1, together with the computer system 30, can be protected from theft.

Optionally, a locking mechanism is provided to secure the drawer 14 within the receiving space 5. To that end, a locking element is provided on the drawer 14 that interacts with a counter-locking element of one or both side walls 3. Alternatively, one or multiple locking elements are provided on both side walls 3 and/or the base plate 2. Instead of one or multiple locking elements, clamping, latching, or spring elements or a snap element can also be provided, respectively interacting with corresponding counter elements. In other words, alternatively, a clamp mechanism, a latch mechanism, a spring mechanism or a snap mechanism is provided. Thereby, the drawer 14 is securely held in the receiving space 5 in the inserted state.

Analogously, the cover plate 4 comprises a latch element so that the cover plate 4 can latch with the side walls 3. Alternatively, the cover plate 4 latches with the lower end of the holding arm 6. The latch element is, for example, a part of a grip element 20 of the cover plate 4, which can be actuated from the outside. In the example, the grip element 20 is configured as a resilient tab. Alternatively, a latching element provided in a different location, is actuated via the grip element 20. Via the grip element 20, the latching connection can be released and the cover plate 4 can be withdrawn from the carrier mount 1.

FIGS. 6 and 7 further illustrate the optional holding clamp 22 arranged on the holding arm 6 and engaging around the computer system 30 on one side. The holding clamp 22 is, for example, hung in an opening provided in holding arm 6 or latched with this opening. Alternative fixing options are possible. Engaging around the computer system 30 can optionally be effected by latching.

The features described herein are to be regarded separately and can be combined with each other in different ways. Furthermore, the above described features can form a part of a mounting method of mounting the carrier mount 1.

1. A carrier mount for a monitor of a computer system comprising:
a base plate;
two side walls arranged oppositely on the base plate; and
a cover plate arrangable at the side walls so that, together with the side walls and the base plate, a receiving space is defined;
wherein the receiving space is formed such that a computer system can selectively at least partially be received therein or a drawer can be inserted.

2. The carrier mount according to claim 1, wherein the side walls are configured such that a holding arm for the monitor is attachable on the side walls and/or the cover plate.

3. The carrier mount according to claim 1, wherein the receiving space is configured to be open on a front side and a back side.

4. The carrier mount according to claim 1, wherein a side wall and/or the base plate comprises a first guide element.

5. The carrier mount according to claim 1, wherein at least one locking element, latching element and/or clamping element is provided on a side wall and/or the base plate for locking, latching and/or jamming with the drawer.

6. The carrier mount according to claim 1, wherein a stop element is arranged on the base plate and/or a side wall.

7. The carrier mount according to claim 1, wherein a side wall and/or the base plate comprise a second guide element.

8. The carrier mount according to claim 1, wherein the cover plate is slidably guided along the side walls.

9. The carrier mount according to claim 1, wherein the cover plate is configured as a mounting plate, on which the computer system or a housing thereof, can be fixed.

10. The carrier mount according to claim 9, wherein the cover plate comprises a mounting area for the computer system and a reinforcement plate is arranged in the area of the mounting area on an inner side of the cover plate facing the receiving space.

11. The carrier mount according to claim 1, wherein the cover plate comprises a latching element configured to latch the cover plate with the side walls and/or with a holding arm for the monitor mounted on the carrier mount.

12. The carrier mount according to claim 1, wherein the cover plate comprises a bore that screws the cover plate to a holding arm for the monitor mounted on the carrier mount.

13. The carrier mount according to claim 1, wherein the cover plate comprises an opening configured to receive a Kensington lock so that the cover plate can be secured on a holding arm for the monitor mounted on the carrier mount.

14. An assembly with the carrier mount according to claim 1 and a computer system, wherein
the carrier mount comprises a base plate, two side walls arranged opposite the base plate, and a cover plate arranged on the side walls so that, together with the side walls and the base plate, a receiving space is defined;
the carrier mount comprises a holding arm for the monitor;
the cover plate is configured as a mounting plate on which a housing of the computer system is fixed; and
a drawer can be inserted in the receiving space (5).

15. The assembly according to claim 14, wherein the cover plate is slidably guided along the side walls and for mounting of the assembly, the computer system is initially mounted on the cover plate via the housing and is subsequently inserted together with the cover plate.

16. An assembly with the carrier mount according to claim 1 and a computer system, wherein
the carrier mount comprises a base plate, two side walls arranged opposite the base plate, and a cover plate arranged on the side walls so that, together with the side walls and the base plate, a receiving space is defined;
the carrier mount comprises a holding arm for the monitor; and
the computer system is at least partially received in the receiving space.
